(19) United States
(12) Patent Application Publication
(10) Pub. No.: US 2014/0075547 A1
(43) Pub. Date: Mar. 13, 2014

(54) INFORMATION PROCESSING APPARATUS, INFORMATION PROCESSING METHOD, AND COMPUTER READABLE MEDIUM

(71) Applicant: FELICA NETWORKS, INC., Tokyo (JP)

(72) Inventor: Tsutomu Kumai, Tokyo (JP)

(73) Assignee: FELICA NETWORKS, INC., Tokyo (JP)

(21) Appl. No.: 14/013,246

(22) Filed: Aug. 29, 2013

(30) Foreign Application Priority Data
Sep. 7, 2012 (JP) 2012-196734

(51) Int. Cl. G06F 21/31

(52) U.S. Cl. CPC G06F 21/31
USPC 726/18

(57) ABSTRACT

There is provided an information processing apparatus including: a display unit that displays an input interface which includes a plurality of identification information figures corresponding to identification information used to identify an individual, and a reference figure functioning as a reference for arrangement of the identification information figures; a display control unit that hides the identification information figures, which are targets of an operation performed by a user, or changes display positions of the identification information figures with regard to the reference figure, in accordance with the operation performed by the user on the input interface; and an identification information specifying unit that specifies the identification information which is used for a certification process from among a plurality of pieces of identification information in accordance with the operation performed by the user on the input interface.

### BACKGROUND

The present disclosure relates to an information processing apparatus, an information processing method, and a computer readable medium, and, in particular, to an information processing apparatus, an information processing method, and a computer readable medium which enable a higher-security certification process to be easily performed.

In recent years, for example, when a mobile terminal, such as a smart phone or the like, returns from a locked state in which the functions of a main body are locked, it is possible to make a setting such that a certification process is performed using a passcode, a pattern lock or the like.

The passcode is a certification process using numerals (hereinafter, appropriately, called a Personal Identification Number (PIN)) in order to identify an individual. Generally, a four-digit PIN is most widely used for the passcode. In this case, since there are maximum 10000 different combinations of the PIN, there is a problem in that the locked state is easily released by performing a so-called round-robin. In addition, since there is a strong tendency that a four-digit numeral (for example, the number of a vehicle, the lower four digits of a telephone number, or the like) which is easily memorized by a user is used as the PIN and such a four-digit numeral is analogized, it is conceivable that a risk of the release of the locked state of a terminal device increases.

The pattern lock is a certification process using a track which follows a plurality of dots. Generally, in many cases, the pattern lock uses a track which follows dots arranged 3×3. In this case, there are approximately 390000 different combinations of the track which follows the dots, and it is considered that the security thereof is higher than that of the passcode. However, it is estimated that an initially-selected start point is affected by the dominant arm of the user (for example, it is difficult for a right-handed user to select the left top) and there is a strong possibility that the corners of a screen which hardly reaches due to the increase in size of the screen are seldom selected. Therefore, it is easy to analogize the combination of the track. In addition, it is estimated that there are extremely rare cases in which a track having a complicated pattern is set because of a problem in that the pattern may be forgotten.

In addition, for example, Japanese Unexamined Patent Application Publication No. 2012-33086 discloses a certification process to transmit the rotation amount and rotation direction of a dial without transmitting an actual passcode value. If the certification process is performed, the passcode is not transmitted. Therefore, even when a password is cracked (extracted), it is possible to prevent the passcode from being revealed.

### SUMMARY

As described above, although the certification process, such as the passcode, the pattern lock, or the like, has been used from the related art, it is desirable to easily perform a higher-security certification process.

For example, in the certification process disclosed in Japanese Unexamined Patent Application Publication No. 2012-33086, if a long passcode is set to transmit the rotation amount and the rotation direction, many steps should be taken until the locked state is released. Therefore, since a long period of time is desired to release the locked state, it is surmised that a user feels that the certification process is troublesome.

It is desirable to enable a higher-security certification process to be easily performed.

An information processing apparatus according to an embodiment of the present disclosure includes: a display unit that displays an input interface which includes a plurality of identification information figures corresponding to identification information used to identify an individual, and a reference figure functioning as a reference for arrangement of the identification information figures; a display control unit that hides the identification information figures, which are targets of an operation performed by a user, or changes display positions of the identification information figures with regard to the reference figure, in accordance with the operation performed by the user on the input interface; and an identification information specifying unit that specifies the identification information which is used for a certification process from among a plurality of pieces of identification information in accordance with the operation performed by the user on the input interface.

An information processing method or a computer readable medium storing a program according to another embodiment of the present disclosure includes: displaying an input interface which includes a plurality of identification information figures corresponding to identification information used to identify an individual, and a reference figure functioning as a reference for arrangement of the identification information figures; hiding the identification information figures, which are targets of an operation performed by a user, or changing display positions of the identification information figures with regard to the reference figure, in accordance with the operation performed by the user on the input interface; and specifying the identification information which is used for a certification process from among a plurality of pieces of identification information in accordance with the operation performed by the user on the input interface.

According to the embodiments of the present disclosure, the input interface is displayed which includes the plurality of identification information figures corresponding to the identification information used to identify an individual and the reference figure functioning as a reference for arrangement of the identification information figures. The identification information figures are hidden which are targets of an operation performed by a user in accordance with the operation performed by the user on the input interface and the display positions of the identification information figures with regard to the reference figure are changed. Further, the identification information which is used for the certification process is specified from among the plurality of pieces of identification information in accordance with the operation performed by the user on the input interface.

According to the embodiments of the present disclosure, it is possible to easily perform a higher-security certification process.

### BRIEF DESCRIPTION OF THE DRAWINGS

FIG. 1 is a block diagram illustrating a configuration example of an information processing apparatus according to an embodiment of the present disclosure.

FIG. 2 is a view illustrating a certification screen.

FIG. 3 is a view illustrating an operation performed on an input interface.

FIG. 4 is a flowchart illustrating a certification process.

FIG. 5 is a view illustrating a first modification example of the input interface.

FIGS. 6A and 6B are views illustrating a second modification example of the input interface.

FIGS. 7A and 7B are views illustrating a third modification example of the input interface.

FIGS. 8A and 8B are views illustrating a modification example of the certification screen.

FIG. 9 is a view illustrating an operation to determine a PIN.

FIG. 10 is a block diagram illustrating a configuration example of a computer according to an embodiment of the present disclosure.

### DETAILED DESCRIPTION OF EMBODIMENTS

Hereinafter, a specific embodiment to which the present disclosure is applied will be described in detail with reference to the accompanying drawings.

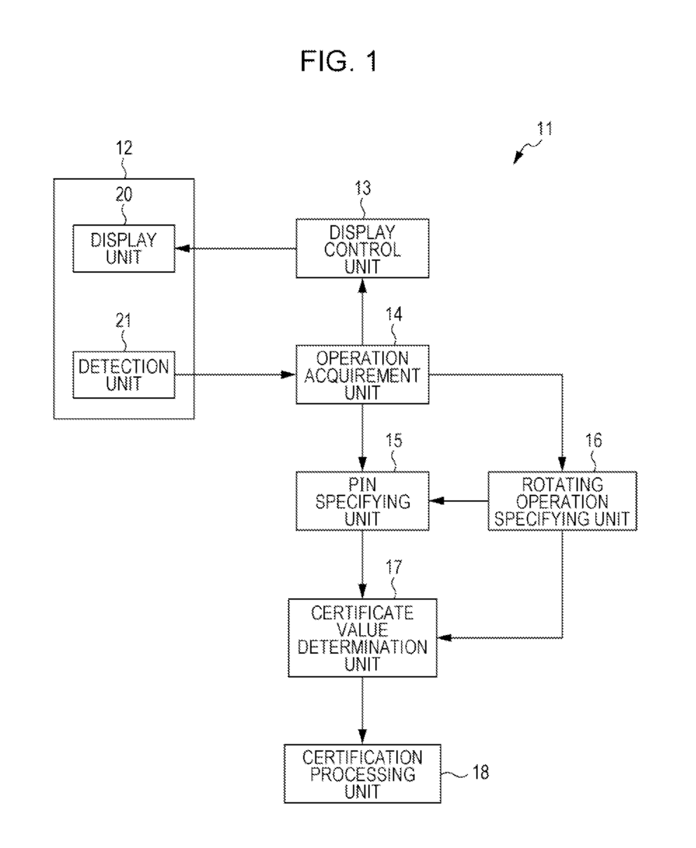

FIG. 1 is a block diagram illustrating a configuration example of an information processing apparatus according to an embodiment of the present disclosure.

In FIG. 1, an information processing apparatus 11 is a portable terminal, such as a mobile phone, a tablet device, or the like, and includes a touch panel 12, a display control unit 13, an operation acquirement unit 14, a PIN specifying unit 15, a rotating operation specifying unit 16, a certificate value determination unit 17, and a certification processing unit 18.

The touch panel 12 includes a display unit 20 which is configured with a Liquid Crystal Display (LCD), an organic Electro Luminescence (EL) display, or the like, and a detection unit 21 which detects a touch made by a user using an electrostatic capacitance manner, an optical manner, or the like. In addition, the display unit 20 displays an image under the control of the display control unit 13, and the detection unit 21 supplies touch coordinates indicative of a position, in which a finger of the user touches the surface of the touch panel 12, to the operation acquirement unit 14.

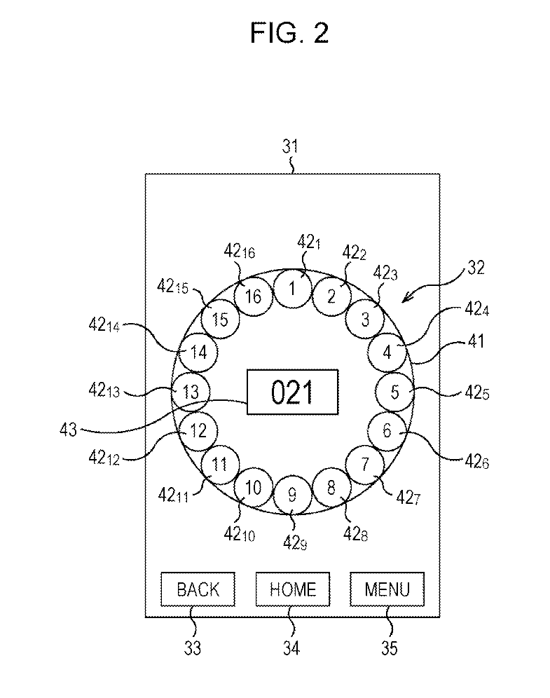

The display control unit 13 controls the display of the display unit 20 of the touch panel 12 depending on an operation performed by the user. For example, if an operation is performed on a button which is not shown in the drawing when the information processing apparatus 11 is in a locked state, the display control unit 13 displays a certification screen (see FIG. 2) on the display unit 20 of the touch panel 12 in order to perform a certification process to release the locked state of the information processing apparatus 11.

The operation acquirement unit 14 acquires the operation performed by the user on the touch panel 12 in accordance with the touch coordinates supplied from the detection unit 21, and supplies operational information in accordance with the operation to the PIN specifying unit 15 and the rotating operation specifying unit 16.

When, for example, the user performs an operation to select a PIN figure 42 on an input interface 32, which will be described later with reference to FIG. 2, based on the operational information supplied from the operation acquirement unit 14, the PIN specifying unit 15 specifies a PIN which corresponds to the selected PIN figure 42 as a PIN which is used for the certification process to release the locked state of the information processing apparatus 11. In addition, at this time, the PIN specifying unit 15 records the order of the selected PIN figure 42.

When, for example, the user performs a rotating operation on the input interface 32, which will be described later with reference to FIG. 2, based on the operational information supplied from the operation acquirement unit 14, the rotating operation specifying unit 16 specifies the rotation direction and the rotation angle of the rotating operation.

The certificate value determination unit 17 determines a certificate value used to perform the certification process to release the locked state of the information processing apparatus 11 in accordance with the PIN which is specified by the PIN specifying unit 15 and the rotation direction and the rotation angle which are specified by the rotating operation specifying unit 16.

The certification processing unit 18 performs the certification process to release the locked state of the information processing apparatus 11 in such a way as to determine whether or not the certificate value which is determined by the certificate value determination unit 17 is identical to a certificate value which is set in advance in the information processing apparatus 11. Here, for example, the user designates a PIN, a rotation direction and a rotation angle in the information processing apparatus 11, and a certificate value, which is determined by the certificate value determination unit 17 based on the designated PIN, the rotation direction, and the rotation angle, is set in advance.

Meanwhile, although the certification process to release the locked state of the information processing apparatus 11 is described in the embodiment, the present disclosure can be applied to other certification processes in addition thereto. For example, the certificate value which is determined by the certificate value determination unit 17 is transmitted to an external server, and a certification process to access the server may be performed. In addition, the certification process can be performed in such a way that a PIN which is specified by the PIN specifying unit 15 and a rotation direction and a rotation angle which are specified by the rotating operation specifying unit 16 are transmitted to the external server, and the server determines a certificate value.

Subsequently, FIG. 2 is a view illustrating an example of the certification screen which is displayed on the display unit 20 of the touch panel 12 in the certification process to release the locked state of the information processing apparatus 11.

As shown in FIG. 2, an input interface 32 is displayed at the center of the certification screen 31, and a back button 33, a home button 34, and a menu button 35 are displayed in line at the base of the certification screen 31.

The input interface 32 is a Graphical User Interface (GUI) which is used to input a PIN, a rotation direction, and a rotation angle which are necessary to determine a certificate value in order to perform the certification process. As shown in FIG. 2, in the input interface 32, circular PIN figures 42₁ to 42₁₆ are arranged along the inner circumference of the circular reference figure 41 such that the circular PIN figures 42₁ to 42₁₆ come into contact with the inside of the circular reference figure 41, and an angle display unit 43 is arranged at the center of the reference figure 41.

The reference figure 41 is the reference of the arrangement of the PIN figures 42₁ to 42₁₆, and the center of the reference figure 41 is the center when the user performs a rotating operation on the input interface 32. For example, if the user performs an operation to move a finger along a circumference on the inside of the reference figure 41 while the surface of the touch panel 12 is being touched, it is determined by the rotating operation specifying unit 16 that the rotating operation is performed depending on the operational information in accordance with the operation, and the rotation direction and the rotation angle are specified in the information processing apparatus 11.

The PIN figures 42₁ to 42₁₆ are figures which correspond to a PIN which is identification information used to identify an individual. The PIN figures 42₁ to 42₁₆ are respectively marked with corresponding numerals, and a PIN is selected in accordance with an operation performed on the PIN figures 42₁ to 42₁₆. For example, if the user performs an operation to touch and separate from the surface of the touch panel 12 for a short time on any one of the PIN figures 42₁ to 42₁₆, it is determined by the PIN specifying unit 15 that the PIN figure 42 is tapped in accordance with the operational information in accordance with the operation in the information processing apparatus 11. Further, the tapped PIN figure 42 is hidden, and a PIN, which corresponds to a final remaining PIN figure 42, is specified as a PIN which is used for the certification process to release the locked state of the information processing apparatus 11.

The angle display unit 43 displays a rotation angle, obtained when the user performs the rotating operation on the input interface 32, in real time.

The back button 33 is a GUI which is operated when the display of the display unit 20 is returned to an immediate previous state. In addition, the home button 34 is a GUI which is operated when a home screen is displayed on the display unit 20, and a menu button 35 is a GUI which is operated when a menu screen is displayed on the display unit 20.

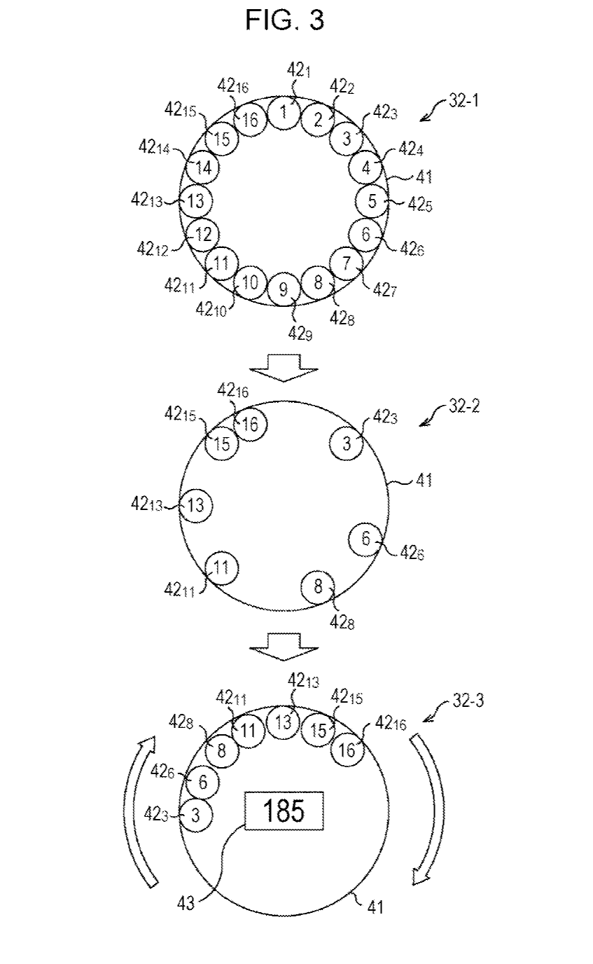

Subsequently, an operation performed on the input interface 32 will be described with reference to FIG. 3.

First, if the certification process starts, an input interface 32-1, which is shown on the upper side of FIG. 3, is displayed. In the input interface 32-1, a basic figure 41 and PIN figures 42₁ to 42₁₆ are displayed.

Further, if the user taps any one of the PIN figures 42₁ to 42₁₆ on the input interface 32-1, the tapped PIN figure 42 is hidden. For example, in the information processing apparatus 11, the plurality of PIN figures 42 are tapped and the PIN figures 42 are hidden. Therefore, a PIN corresponding to a remaining PIN figure 42 which is being displayed is specified as a PIN which is used for the certification process to release the locked state of the information processing apparatus 11.

That is, when PINs, which are designated by the user when a certificate value is set, are 3, 6, 8, 11, 13, 15, and 16, the user taps the PIN figure 42₁, the PIN figure 42₂, the PIN figure 42₄, the PIN figure 42₅, the PIN figure 42₇, the PIN figure 42₉, the PIN figure 42₁₀, the PIN figure 42₁₂ and the PIN figure 42₁₄, and the tapped PIN figures are hidden. Here, when the PIN figure 42 which is tapped by the user is hidden, the display control unit 13 may not only simply hide the PIN figure 42 but also perform, for example, animation display such that the PIN figure 42 moves to the outside of the reference figure 41 and disappears out of the certification screen 31.

Therefore, similar to an input interface 32-2 which is shown at the center of FIG. 3, a state is made in which only the PIN figure 42₃, the PIN figure 42₆, the PIN figure 42₈, the PIN figure 42₁₁, the PIN figure 42₁₃, the PIN figure 42₁₅, and the PIN figure 42₁₆ are displayed. Thereafter, if it is detected that the user starts the rotating operation on the input interface 32-2, PINs corresponding to the PIN figures 42 which are being displayed (in the example, 3, 6, 8, 11, 13, 15, and 16) are specified as PINs which are used for the certification process to release the locked state of the information processing apparatus 11.

In addition, if the user performs the rotating operation on the input interface 32, the angle display unit 43 is displayed at the center of the basic figure 41 like an input interface 32-3 which is shown on the lower side of FIG. 3. Further, a rotation angle, which corresponds to the rotating operation performed by the user, is displayed on the angle display unit 43 in real time.

At this time, the user performs a rotating operation, in which the center of the basic figure 41 is set to a rotation center, in the rotation direction designated when the certificate value is set until the designated rotation angle is made. When the rotation direction and the rotation angle, which are designated by the user when the certificate value is set, are the right direction and 185°, the user performs the rotating operation to rotate the input interface 32 in the right direction by 185° like the input interface 32-3. Further, if the user lifts a finger from the surface of the touch panel 12 in this state, the rotation direction and the rotation angle at this time are specified as the rotation direction and the rotation angle which are used for the certification process to release the locked state of the information processing apparatus 11. Meanwhile, if the user performs, for example, an operation to double tap the basic figure 41 after performing the rotating operation on the input interface 32 or to tap the angle display unit 43 in addition to the separation of a finger from the surface of the touch panel 12, the rotation direction and the rotation angle may be specified.

Meanwhile, the input interface 32-3 displays, for example, a state in which the user performs the rotating operation by touching the PIN figure 42₃. As shown in the drawing, in order to visually implement the rotating operation performed on the input interface 32, rotation display is performed such that the PIN figure 42 moves along the inner circumference of the basic figure 41 depending on the rotation angle so as to be a so-called chain-reaction state. In addition, if such a rotating display is performed, for example, all the PIN figures 42 are tilted on the left side when the rotating operation corresponds to rotation to the right, and thus it is possible to cause the user to visually recognize the rotation direction.

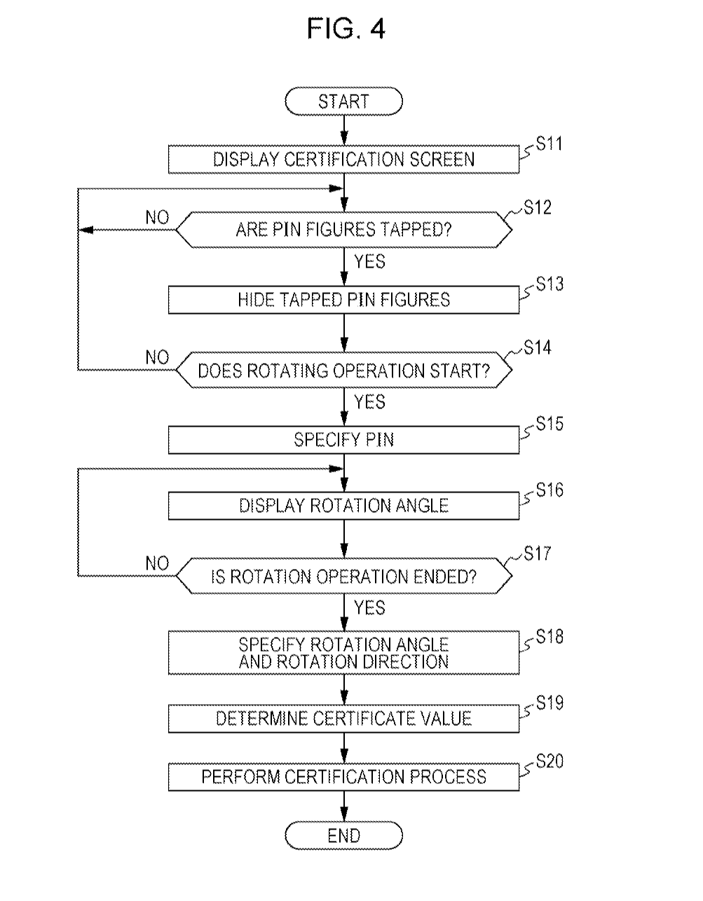

Subsequently, FIG. 4 is a flowchart illustrating the certification process which is performed in the information processing apparatus 11.

For example, if the user performs an operation to press a predetermined button when the information processing apparatus 11 is in the locked state, the certification process starts. In step S11, the display control unit 13 displays the certification screen 31 on the display unit 20 of the touch panel 12. Thereafter, the operation acquirement unit 14 starts the acquirement of an operation, which is performed by the user on the touch panel 12, in accordance with touch coordinates supplied from the detection unit 21. If the operation is performed by the user, the operation acquirement unit 14 supplies operational information to the PIN specifying unit 15 and the rotating operation specifying unit 16.

In step S12, the PIN specifying unit 15 determines whether or not the PIN figure 42 is tapped based on the operational information supplied from the operation acquirement unit 14. For example, when the operational information supplied from the operation acquirement unit 14 indicates that touch is perform by the user for a short time and any one of the PIN figures 42₁ to 42₁₆ is displayed at the touch coordinates at that time, the PIN specifying unit 15 determines that the PIN figure 42 which is displayed at the touch coordinates display is tapped.

In the information processing apparatus 11, the process stands by until the PIN specifying unit 15 determines that the PIN figure 42 is tapped in step S12. If the PIN specifying unit 15 determines that the PIN figure 42 is tapped, the process proceeds to step S13.

In step S13, the PIN specifying unit 15 specifies the PIN figure 42 which is tapped by the user and provides notification to the display control unit 13, and the display control unit 13 hides the PIN figure 42. At this time, the display control unit 13 performs, for example, animation display such that the PIN figure 42 which is tapped by the user moves toward the outside of the basic figure 41 and the PIN figure 42 disappears out of the certification screen 31.

In step S14, the rotating operation specifying unit 16 determines whether or not the rotating operation starts on the input interface 32 based on the operational information which is supplied from the operation acquirement unit 14. For example, when the operational information which is supplied from the operation acquirement unit 14 indicates that the touch coordinates indicative of a position touched by the user move along the circumference on the inside of the reference figure 41, the rotating operation specifying unit 16 determines that the rotating operation starts on the input interface 32.

In step S14, when the rotating operation specifying unit 16 determines that the rotating operation does not start, the process returns to step S12, and the same processes are repeated thereafter. On the other hand, when the rotating operation specifying unit 16 determines that the rotating operation starts in step S14, the process proceeds to step S15.

In step S15, the rotating operation specifying unit notifies the PIN specifying unit 15 that the rotating operation starts, and the PIN specifying unit 15 specifies a PIN, which corresponds to the PIN figure 42 that is being displayed at that time, as a PIN which is used for the certification process.

In step S16, the rotating operation specifying unit notifies the display control unit 13 of the rotation direction and the rotation angle in accordance with the rotating operation performed by the user, and the display control unit 13 displays the rotation angle on the angle display unit 43 and performs the rotating display as described above with reference to the input interface 32-3 in FIG. 3.

In step S17, the rotating operation specifying unit 16 determines whether or not the rotating operation performed on the input interface 32 ends based on the operational information which is supplied from the operation acquirement unit 14. For example, when the operation acquirement unit 14 detects that a finger of the user is lifted from the surface of the touch panel 12, the rotating operation specifying unit determines that the rotating operation performed on the input interface 32 ends.

In step S17, the rotating operation specifying unit determines that the rotating operation performed on the input interface 32 does not end, the process returns to step S16, and the same processes are repeated thereafter. On the other hand, when the rotating operation specifying unit 16 determines that the rotating operation performed on the input interface 32 ends in step S17, the process proceeds to step S18.

In step S18, the rotating operation specifying unit specifies the rotation angle and the rotation direction, which are obtained at the time that the rotating operation ends, as a rotation angle and a rotation direction which are used for the certification process.

In step S19, the certificate value determination unit 17 determines the certificate value based on the PIN which is specified by the PIN specifying unit 15 in step S15 and the rotation angle and the rotation direction which are specified by the rotating operation specifying unit 16 in step S18.

For example, the certificate value determination unit 17 determines a value, which is calculated by multiplying a specific digit-number numerical value obtained by arranging the PIN specified by the PIN specifying unit 15 in a predetermined order by the rotation angle specified by the rotating operation specifying unit 16, as the certificate value. Alternately, for example, the certificate value determination unit 17 may determine a value, which is calculated by adding a digit-number value obtained by arranging the PIN specified by the PIN specifying unit 15 in a predetermined order to a value which is indicative of the rotation angle and the rotation direction, as the certificate value.

In step S20, the certification processing unit 18 performs the certification process to release the locked state of the information processing apparatus 11 by determining whether or not the certificate value which is determined by the certificate value determination unit 17 coincides with the certificate value which is set in the information processing apparatus 11 in advance in step S19. Meanwhile, when the certification is successful in the certification process, a home screen is displayed on the display unit 20 of the touch panel 12 and the process ends. When the certification fails in the certification process, the process is repeated from step S11 in order to perform certification again.

As described above, in the information processing apparatus 11, when the user taps the PIN figures 42₁ to 42₁₆ of the input interface 32 which are displayed on the certification screen 31 and the PIN figures which are not set as PINs in advance are hidden, it is possible to designate PINs which are used for the certification process. At this time, the user taps the PIN figures while visually recognizing the remaining PIN figure 42, and thus it is possible to easily remember the set PINs and it is possible to further easily perform a recognition process. That is, it is possible to easily perform the certification process using PINs which include additional digit numbers compared to a password according to the related art.

Further, the certification process is performed by combining the PIN with the rotation direction and the rotation angle in the information processing apparatus 11, and thus it is possible to perform certification using a pattern which has a combination surpassing the certification process using a passcode according to the related art. Therefore, for example, it is possible to further improve the security intensity than that of certification performed when a PIN is simply selected. Meanwhile, when the rotation direction and the rotation angle are used, it is possible to improve the security intensity by combining clockwise rotation, counterclockwise rotation, both the clockwise rotation and the counterclockwise rotation, several times of rotation in the same direction, and the like.

In addition, the user can hide a PIN which is set in advance by determining the certificate value in such a way as to combine the PIN, which is specified using the PIN figures 42₁ to 42₁₆, with the rotation direction and the rotation angle, which are acquired by performing the rotating operation on the input interface 32, and thus it is possible to further improve the security intensity.

In addition, in the certification process disclosed in the above-described Japanese Unexamined Patent Application Publication No. 2012-33086, the number of steps, performed until the locked state is released, increases in proportion to the increase of the length of the passcode, and thus a long period of time is necessary to perform the certification process. In contrast, even when a certificate value having a long digit number is used in the information processing apparatus 11, it is possible to input the certificate value by performing an easy operation on the input interface 32, and thus it is possible to hide the PIN which is set in advance by the user.

Meanwhile, the PIN figure 42 to be hidden may be randomly selected by the user. However, for example, the order in which the PIN figure 42 is hidden is set in advance, and the user may tap the PIN figure 42 in that order. In this case, for example, the PIN specifying unit 15 specifies the PIN figure 42 which is tapped by the user and records the order in which the PIN figure 42 is tapped in step S13 of the flowchart of FIG. 4. Thereafter, the certification processing unit 18 performs the certification process which determines whether or not the PIN figure 42 is tapped in the order, and thus it is possible to further improve the security intensity.

In addition, in the information processing apparatus 11, it is possible to adjust the certification intensity by setting the number of PIN figures 42 which are displayed on the input interface 32, the digit number of a PIN which is used for the certification process, and the rotation direction and the rotation angle of the rotating operation which is performed on the input interface 32. For example, when sixteen PIN figures 42 are used as shown in FIG. 2 and the setting is made such that a 5-digit PIN is used for the certification process and the rotating operation is performed twice on the input interface 32 in a predetermined rotation direction and at a predetermined rotation angle, it is possible to set 3,144,960 (=(16×15×14×13×12)/(5×4×3×2×1)×360×2) types of certification intensity. Further, when certification is performed while recording the sequence of the input of a 5-digit PIN, permutation is simple because repetition may be not considered, and thus it is possible to greatly improve the intensity as 377,395,200 (=(16×15×14×13×12)×360×2). In addition, it is possible to easily improve the certification intensity by increasing the number of PIN figures 42 to be used for the input interface 32 to, for example, 18.

Further, in the information processing apparatus 11, when the rotating operation is performed on the input interface 32, it is possible to make a setting such that the rotating operation is performed by touching a specific PIN figure 42 which is determined in advance. Further, it is possible to make a setting such that the certification is successful when the user performs the rotating operation while touching the specific PIN figure 42 from among selected PIN figures 42. In this case, for example, the certification processing unit 18 performs the certification process to determine whether or not the rotating operation is performed by touching the specific PIN figure 42, and thus it is possible to further improve the security intensity.

As described above, since the input interface 32 is used in the information processing apparatus 11, it is possible to easily input a further multiple-digit number certificate value with one hand through a few steps without repeating the same process multiple times, and it is possible to perform the certification process during a short time. In addition, since the input interface 32 is used, it is possible to enable the user to clearly understand a simple operation and high intensity, and it is possible to implement the certification process which can be easily used by the user. Further, since the number of PIN figures 42 which are used for the input interface 32 is appropriately set as described above, it is possible to universally and easily set and change the certification intensity.

Meanwhile, the present disclosure can be applied to different variations of input interfaces 32 in addition to the above-described input interface 32.

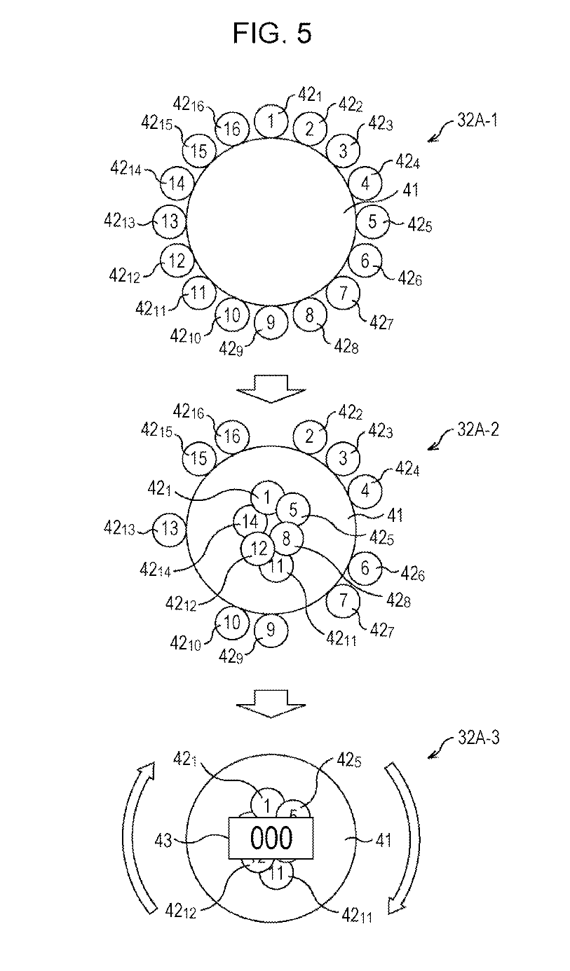

A first modification example of the input interface 32 will be described with reference to FIG. 5.

First, if the certification process starts, an input interface 32A-1 which is shown on the upper side of FIG. 5 is displayed. In the input interface 32A-1, PIN figures 42₁ to 42₁₆ are arranged along the outer circumference of a reference figure 41 so as to come into contact with the outside of the reference figure 41.

Further, if the user taps any one of the PIN figures 42₁ to 42₁₆ on the input interface 32A-1, the tapped PIN figure 42 moves to inside of the reference figure 41. In an input interface 32A-2 which is shown at the center of FIG. 5, a state is shown in which the PIN figure 42₁, the PIN figure 42₅, the PIN figure 42₈, the PIN figure 42₁₁, the PIN figure 42₁₂, and the PIN figure 42₁₄ are tapped.

Thereafter, if the user starts the rotating operation on the input interface 32A, a PIN, which corresponds to the PIN figures 42 which are displayed on the inside of the reference figure 41 at that time, is specified as a PIN which is used for the certification process. Further, the angle display unit 43 is displayed like an input interface 32A-3 which is shown on the lower side of FIG. 5.

As described above, the user may select the PIN figures 42 which are arranged on the outside of the reference figure 41, and the PINs, which correspond to the PIN figures 42 which move to the inside of the reference figure 41 at that time, may be specified as the PINs which are used for the certification process.

Meanwhile, the PIN figures 42 which move to the inside of the reference figure 41 may be randomly selected by the user. However, for example, an order in which the PIN figures 42 move to the inside of the reference figure 41 may be set in advance, and the user may tap the PIN figures 42 in that order. In this case, for example, the PIN specifying unit 15 specifies the PIN figures 42 which are tapped by the user and records an order in which the PIN figures 42 are tapped in step S13 of the flowchart in FIG. 4. Further, the certification processing unit 18 performs the certification process to determine whether or not the PIN figures 42 are tapped in the order, and thus it is possible to further improve the security intensity.

In addition, although the PIN figures 42 are marked with numerals corresponding to the PINs in the input interfaces 32 and 32A, the PIN figures 42 may be marked with patterns, for example, Alphabet, symbols, emoticon, and the like in addition to the numerals.

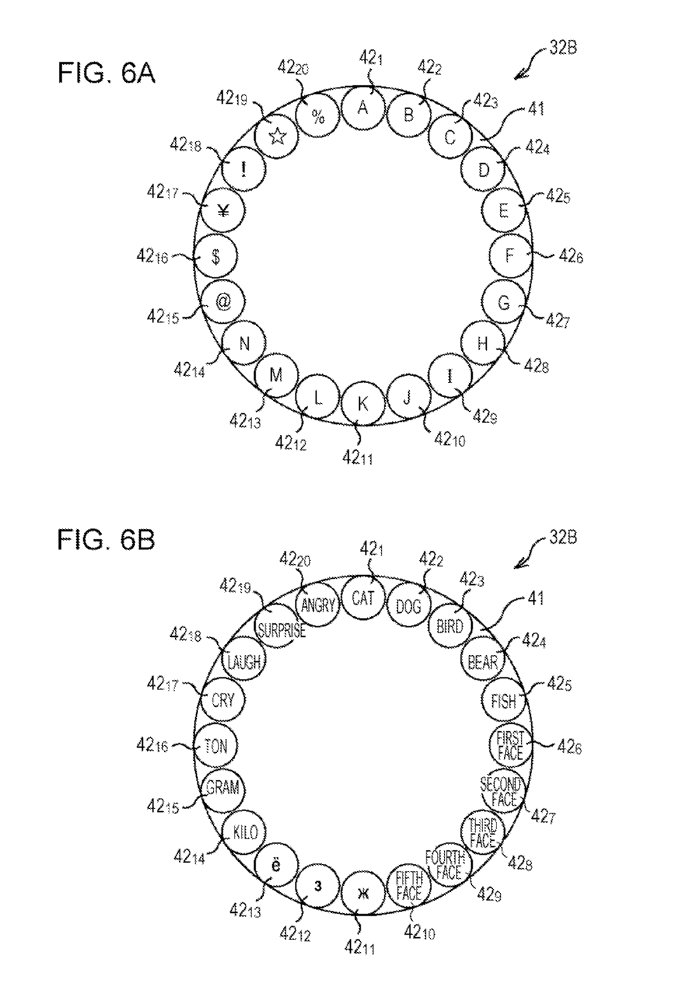

A second modification example of the input interface 32 will be described with reference to FIGS. 6A and 6B.

FIG. 6A shows an input interface 32B in which the PIN figures 42 are marked with Alphabets and symbols, and FIG. 6B shows an input interface 32C in which the PIN figures 42 are marked with emoticons and symbols. Meanwhile, although Chinese characters, such as a cat, a dog, and the like are marked in the input interface 32C, emoticons of animals which respectively correspond thereto are actually marked.

As described above, for example, it is possible to avoid the use of numerals, such as the number of vehicle, a telephone number, or the like which is easily analogized by a person other than the user, as a PIN by marking the PIN figures 42 with Alphabets, symbols, emoticons, and the like in addition to numerals, and thus it is possible to improve the security intensity.

In addition, it is possible to use an elliptical shape, a square shape, a polygonal shape, or the like as the reference figure 41 in addition to the circular shape in the input interface 32.

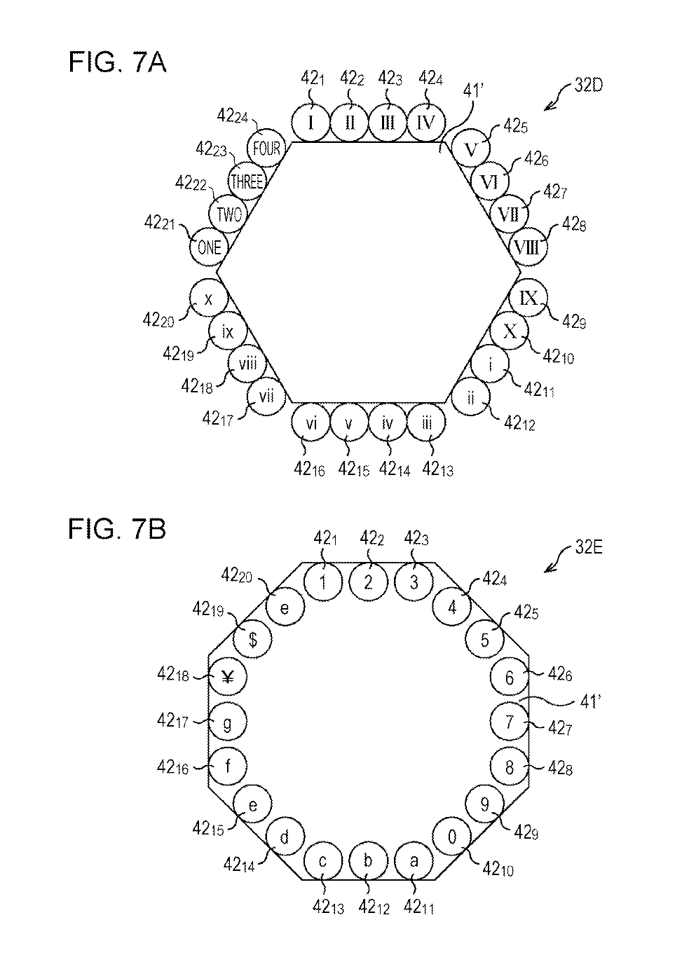

A third modification example of the input interface 32 will be described with reference to FIGS. 7A and 7B.

FIG. 7A shows an input interface 32D in which a hexagonal reference figure 41′ is used and the PIN figures 42 are arranged on the outside of the reference figure 41′. In addition, FIG. 7B shows an input interface 32E in which an octagonal reference figure 41′ is used and the PIN figures 42 are arranged on the inside of the reference figure 41′.

When such a polygonal reference figure 41′ is used, for example, it is possible to use an operation to perform swiping toward the outside of the reference figure 41′, the center of the reference figure 41′, or other opposite sides or vertexes of the reference figure 41′ for the certification by touching an arbitrary side of the polygonal reference figure 41′ in addition that the rotating operation performed on the input interface 32D is used for the certification. Further, an operation to perform swiping such that the number of vertexes is changed (for example, an heptagon or a pentagon is made by moving the octagonal vertexes, or a nonagon or a decagon is made by moving the sides of the octagon) by moving an arbitrary vertex or side of the reference figure 41′ may be used for the certification.

However, when the size of the touch panel 12 is large, it is presumed that it is difficult for a finger of the user to reach the four corners of the touch panel 12, and thus it is desirable to use the circular reference figure 41 when the input interface 32 is fully displayed on the screen of the touch panel 12.

In addition, although the example in which the input interface 32 is arranged at the center of the certification screen 31 is shown in the certification screen 31 in FIG. 2, the input interface 32 may be arranged in a place other than the center of the screen.

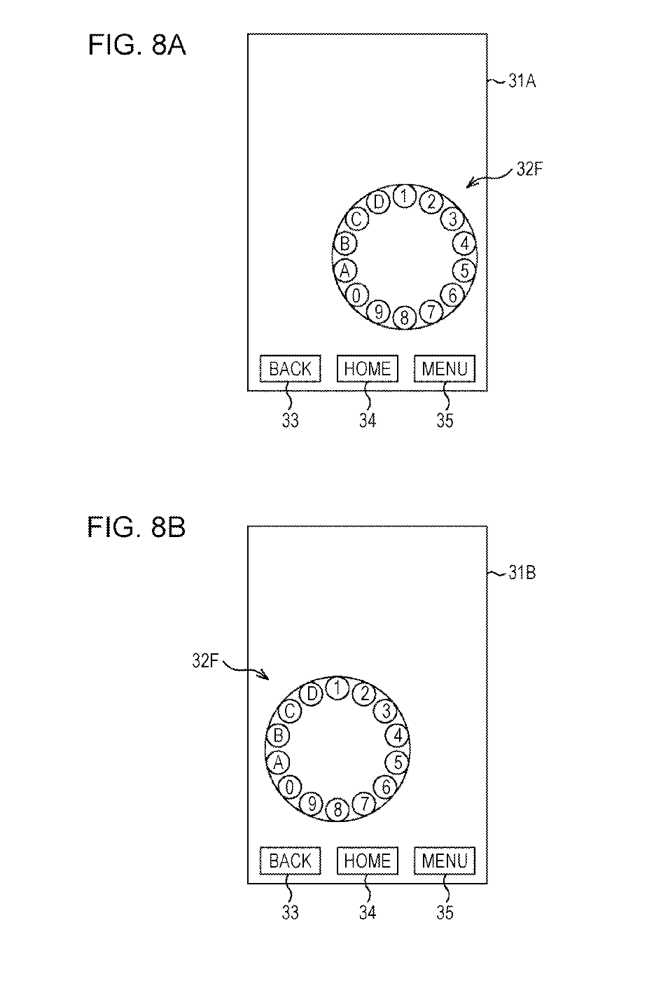

A modification example of the certification screen 31 will be described with reference to FIGS. 8A and 8B.

FIG. 8A shows a certification screen 31A in which an input interface 32F is arranged on the lower right side of the screen, and FIG. 8B shows a certification screen 31B in which the input interface 32F is arranged on the lower left side of the screen.

For example, there is a tendency for the size of the touch panel 12 to increase, and, in the case, it is presumed that it is difficult for a finger of the user to reach the four corners of a screen. Accordingly, the certification screen 31A may be used when the user is right-handed and the certification screen 31B may be used when the user is left-handed in accordance with the dominant arm of the user.

As a result, it is possible to enable the user to easily perform an operation on the input interface 32F using the thumb of the dominant arm by grasping the information processing apparatus 11 with the dominant arm.

In addition, when simple certification is performed in the information processing apparatus 11, the certification process may be performed by only selecting the PIN using the PIN figures 42 without using the rotation direction and the rotation angle, in accordance with the rotating operation performed by the user, for the certification process. In this case, it is not possible to specify a PIN in accordance with the above-described rotating operation that is performed. Therefore, for example, when a determination button is displayed on the certification screen 31 and the user taps the determination button, PINs which correspond to remaining PIN figures 42 are determined as PINs which are used for the certification process.

In addition, in this case, when the user performs an operation to move the input interface 32F to the outside of the certification screen 31, the PIN which corresponds to the remaining PIN figures 42 may be specified as the PINs which are used for the certification process. For example, in the flowchart in FIG. 4, instead of determining whether or not the rotating operation starts in step S14, it is possible to determine whether or not an operation to determine PINs which are used for the certification process is performed based on the operational information which is supplied from the operation acquirement unit 14. Therefore, when the operation to determine PINs which are used for the certification process is performed, a process to determine a certificate value from the PINs (step S19 in FIG. 4) may be performed.

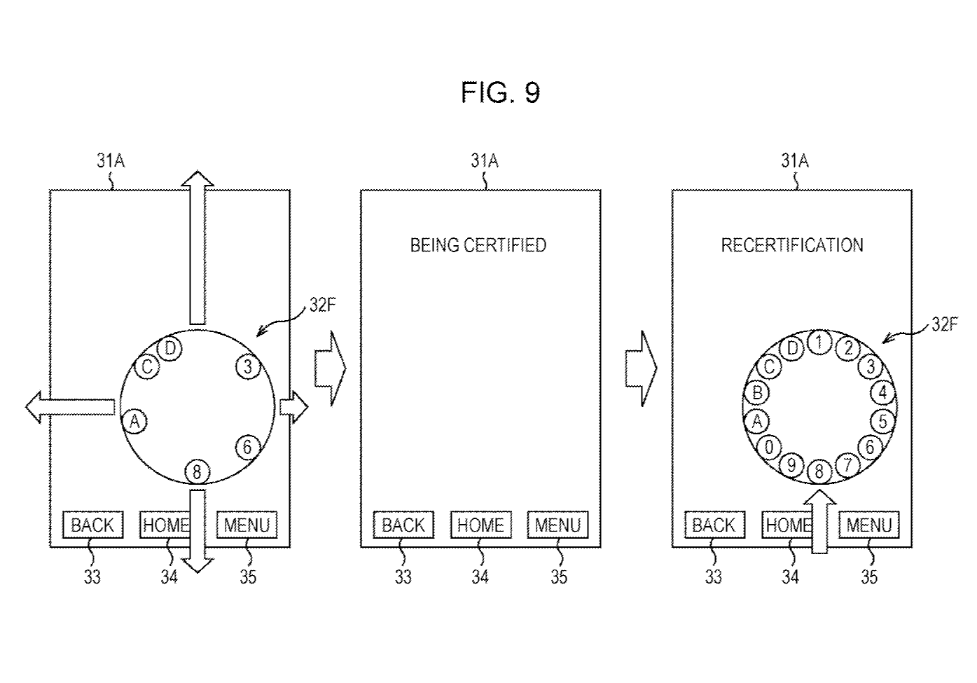

An operation to determine PINs which are selected by the user will be described with reference to FIG. 9.

For example, as shown on the left side in FIG. 9, the user taps the PIN figures 42 other than PINs which are designated when the certificate value is set, the PIN figures are hidden, and the swipe operation to move the input interface 32F in the up and down directions or right and left directions is performed such that the input interface 32F is brought out of the certification screen 31A.

When the operation is performed, the input interface 32F is hidden, and the certification process is performed using PINs corresponding to the PIN figures 42 which remain in the input interface 32F. At this time, a message which indicates that the certification process is being performed is displayed on the certification screen 31A, as shown at the center of FIG. 9.

Thereafter, if the certification is successful, a home screen is displayed. On the other hand, when the certification fails, the input interface 32F in which all the PIN figures 42 are displayed is displayed such that the input interface 32F returns from the outside (for example, lower side) of the certification screen 31A to an original position in order to perform the certification again, and a message which prompts to perform the certification is displayed again, as shown on the right side of FIG. 9.

Meanwhile, in the information processing apparatus 11, the PIN figures 42 may be selected by swiping the PIN figures 42 in addition of selecting the PIN figures 42 by tapping as described above. In addition, the PIN figures 42 may be selected by tapping the plurality of PIN figures 42 at the same time.

For example, when the input interface 32A which is described with reference to FIG. 5 is used, selection is possible from 1 to 16 through a general tap. However, if 4 and 13 are tapped at the same time, a setting can be made such that 52, which is a result of the multiplication thereof, is used as certification (identification) information. Further, in addition to the multiplication of two numerical values as described above, addition, subtraction, or division may be performed. Further, for example, when the input interface 32C which is described with reference to FIG. 6B is used, it is possible to perform conversion into certification (identification) information which is entirely different from the display of the input interface 32C, such as “redfish 70 gram”, by tapping the PIN figure 42₅ which is an emoticon of “fish” and the PIN figure 42₁₄ which is a symbol of “gram” at the same time. It is possible to use a value, which is difficult to be selected under normal circumstances, as the certification information by tapping a plurality of PIN figures 42 at the same time as described above.

Meanwhile, each process which is described with reference to the above-described flowchart is not necessarily processed in chronological order along the order written in the flowchart, and includes processes which are executed in parallel or individually (for example, a parallel process or an object-based process). In addition, a program may be processed by a single CPU, and may be processed by a plurality of CPUs in a distributed manner.

In addition, the above-described series of processes (information processing method) can be executed by hardware and can be executed by software. When the series of processes are executed by software, a program included in the software is installed from a program recording medium which records the program, the program recording medium being a computer which is built with a dedicated hardware or, for example, a general personal computer which can execute various functions by installing various programs.

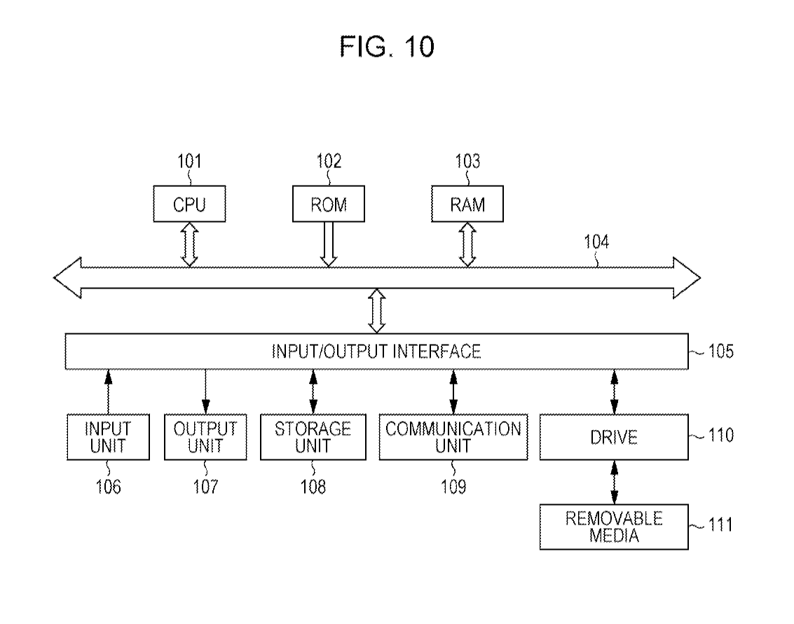

FIG. 10 is a block diagram illustrating a configuration example of the hardware of a computer which executes the above-described series of processes using a program.

In the computer, a Central Processing Unit (CPU) 101, a Read Only Memory (ROM) 102, and a Random Access Memory (RAM) 103 are connected to each other through a bus 104.

The bus 104 is further connected to an input and output interface 105. The input and output interface 105 is connected to an input unit 106 which includes a keyboard, a mouse, a microphone, or the like, an output unit 107 which includes a display, a speaker, or the like, a storage unit 108 which includes a hard disk, a nonvolatile memory, or the like, a communication unit 109 which includes a network interface or the like, and a drive 110 which drives a removable media 111, such as a magnetic disc, an optical disc, a magneto optical disc, a semiconductor memory, or the like.

In the computer which is configured as described above, the above-described series of processes are performed in such a way that the CPU 101 loads, for example, a program stored in the storage unit 108 to the RAM 103 via the input and output interface 105 and the bus 104, and executes the program.

The program which is executed by the computer (CPU 101) is recorded in, for example, a removable media 111 which is a package media that includes the magnetic disc (which includes a flexible disc), the optical disc (Compact Disc-Read Only Memory (CD-ROM), Digital Versatile Disc (DVD), or the like), the magneto optical disc, the semiconductor memory, or the like, and is provided through a wired or wireless transmission medium such as a local area network, the Internet, or digital satellite broadcasting.

Further, the program can be installed in the storage unit 108 through the input and output interface 105 by mounting the removable media 111 on the drive 110. In addition, the program can be received by the communication unit 109 through the wired or wireless transmission medium, and can be installed in the storage unit 108. In addition, the program can be installed in the ROM 102 or the storage unit 108 in advance.

Meanwhile, the present disclosure can include configurations as follows:

(1) An information processing apparatus includes: a display unit that displays an input interface which includes a plurality of identification information figures corresponding to identification information used to identify an individual, and a reference figure functioning as a reference for arrangement of the identification information figures; a display control unit that hides the identification information figures, which are targets of an operation performed by a user, or changes display positions of the identification information figures with regard to the reference figure, in accordance with the operation performed by the user on the input interface; and an identification information specifying unit that specifies the identification information which is used for a certification process from among a plurality of pieces of identification information in accordance with the operation performed by the user on the input interface.

(2) In the information processing apparatus of (1), the plurality of identification information figures are arranged on an inside of the reference figure, and the display control unit moves the identification information figures, which are the targets of the operation performed by the user, to an outside of the reference figure, and moves the identification information figures to an outside of a screen of the display unit, thereby hiding the identification information figures.

(3) In the information processing apparatus of (1) or (2), the plurality of identification information figures are arranged on the outside of the reference figure, and the display control unit moves the identification information figures, which are the targets of the operation performed by the user, to the inside of the reference figure.

(4) The information processing apparatus of any one of (1) to (3) further includes a rotating operation specifying unit that specifies a rotation direction and a rotation angle depending on an operation to rotate the reference figure in accordance with the operation performed by the user on the input interface.

(5) The information processing apparatus of any one of (1) to (4) further includes a certificate value determination unit that determines a certificate value which is necessary for the certification process based on the identification information which is specified by the identification information specifying unit, and the rotation direction and the rotation angle which are specified by the rotating operation specifying unit.

(6) The information processing apparatus of any one of (1) to (5) further includes a certification processing unit that performs the certification process which uses the certificate value determined by the certificate value determination unit.

(7) In the information processing apparatus of any one of (1) to (6), sequence of the identification information figures, which are the targets of the operation performed by the user, is set in advance, and the certification processing unit uses the sequence of the identification information figures, which are the targets of the operation performed by the user, for the certification process.

(8) In the information processing apparatus of any one of (1) to (7), a specific identification information figure, which is designated when the user performs the operation to rotate the reference figure, is set in advance, and the certification processing unit performs the certification process based on whether or not the specific identification information figure is designated and the operation to rotate the reference figure is performed.

Meanwhile, the embodiment is not limited to the above-described embodiment, and various modifications are possible without departing from the gist of the present disclosure.

The present disclosure contains subject matter related to that disclosed in Japanese Priority Patent Application JP 2012-196734 filed in the Japan Patent Office on Sep. 7, 2012, the entire contents of which are hereby incorporated by reference.

What is claimed is:

1. An information processing apparatus comprising:
a display unit that displays an input interface which includes a plurality of identification information figures corresponding to identification information used to identify an individual, and a reference figure functioning as a reference for arrangement of the identification information figures;
a display control unit that hides the identification information figures, which are targets of an operation performed by a user, or changes display positions of the identification information figures with regard to the reference figure, in accordance with the operation performed by the user on the input interface; and
an identification information specifying unit that specifies the identification information which is used for a certification process from among a plurality of pieces of identification information in accordance with the operation performed by the user on the input interface.

2. The information processing apparatus according to claim 1,
wherein the plurality of identification information figures are arranged on an inside of the reference figure, and
wherein the display control unit moves the identification information figures, which are the targets of the operation performed by the user, to an outside of the reference figure, and moves the identification information figures to an outside of a screen of the display unit, thereby hiding the identification information figures.

3. The information processing apparatus according to claim 1,
wherein the plurality of identification information figures are arranged on the outside of the reference figure, and
wherein the display control unit moves the identification information figures, which are the targets of the operation performed by the user, to the inside of the reference figure.

4. The information processing apparatus according to claim 1, further comprising:
a rotating operation specifying unit that specifies a rotation direction and a rotation angle depending on an operation to rotate the reference figure in accordance with the operation performed by the user on the input interface.

5. The information processing apparatus according to claim 4, further comprising:
a certificate value determination unit that determines a certificate value which is necessary for the certification process based on the identification information which is specified by the identification information specifying unit, and the rotation direction and the rotation angle which are specified by the rotating operation specifying unit.

6. The information processing apparatus according to claim 5, further comprising:
a certification processing unit that performs the certification process which uses the certificate value determined by the certificate value determination unit.

7. The information processing apparatus according to claim 6,
wherein sequence of the identification information figures, which are the targets of the operation performed by the user, is set in advance, and
wherein the certification processing unit uses the sequence of the identification information figures, which are the targets of the operation performed by the user, for the certification process.

8. The information processing apparatus according to claim 6,
wherein a specific identification information figure, which is designated when the user performs the operation to rotate the reference figure, is set in advance, and
wherein the certification processing unit performs the certification process based on whether or not the specific identification information figure is designated and the operation to rotate the reference figure is performed.

9. An information processing method comprising:
displaying an input interface which includes a plurality of identification information figures corresponding to identification information used to identify an individual, and a reference figure functioning as a reference for arrangement of the identification information figures;
hiding the identification information figures, which are targets of an operation performed by a user, or changing display positions of the identification information figures with regard to the reference figure, in accordance with the operation performed by the user on the input interface; and
specifying the identification information which is used for a certification process from among a plurality of pieces of identification information in accordance with the operation performed by the user on the input interface.

10. A computer readable medium storing a program which causes a computer to execute an information process comprising:
displaying an input interface which includes a plurality of identification information figures corresponding to identification information used to identify an individual, and a reference figure functioning as a reference for arrangement of the identification information figures;
hiding the identification information figures, which are targets of an operation performed by a user, or changing display positions of the identification information figures with regard to the reference figure, in accordance with the operation performed by the user on the input interface; and
specifying the identification information which is used for a certification process from among a plurality of pieces of identification information in accordance with the operation performed by the user on the input interface.
